(19) United States
(12) Patent Application Publication
(10) Pub. No.: US 2026/0181621 A1
(43) Pub. Date: Jun. 25, 2026

(54) METHOD AND APPARATUS FOR SELECTING BEAM IN WIRELESS COMMUNICATION SYSTEM

(71) Applicants: Samsung Electronics Co., Ltd., Suwon-si, Gyeonggi-do (KR); SEOUL NATIONAL UNIVERSITY R&DB FOUNDATION, Seoul (KR)

(72) Inventors: Jaehong YI, Suwon-si (KR); Sihyun CHOI, Seoul (KR); Saewoong BAHK, Seoul (KR); Deokhui LEE, Suwon-si (KR)

(21) Appl. No.: 19/124,705

(22) PCT Filed: Nov. 3, 2022
(86) PCT No.: PCT/KR2022/017097

§ 371 Date: Apr. 25, 2025

(30) Foreign Application Priority Data
Oct. 26, 2022 (KR) 10-2022-0139228

(51) Int. Cl. H04W 72/044; H04B 7/06; H04L 25/02; H04W 16/28; H04W 24/02; H04W 52/14; H04W 72/23

(52) U.S. Cl. CPC H04W 72/046; H04B 7/063; H04L 25/0204; H04W 16/28; H04W 24/02; H04W 52/146; H04W 72/23

(57) ABSTRACT

The present disclosure relates to a 5G or 6G communication system for supporting a data transmission rate higher than that of a 4G communication system such as LTE. This method performed by means of a base station in a wireless communication system may comprise the steps of: transmitting, to a terminal, a first signal including information related to received power, receiving from the terminal, a second signal including information about received power for the terminal; transmitting the information about the received power to a network entity; and receiving a received power matrix from the network entity.

### CROSS-REFERENCE TO RELATED APPLICATION(S)

This application is a U.S. National Stage application under 35 U.S.C. § 371 of an International application number PCT/KR 2022/017097, filed on Nov. 3, 2022, which is based on and claims priority of a Korean patent application number 10-2022-0139228, filed on Oct. 26, 2022, in the Korean Intellectual Property Office, the disclosure of which is incorporated by reference herein in its entirety.

### TECHNICAL FIELD

The disclosure relates to a method and apparatus for selecting a beam in a wireless communication system and, more particularly, to a method and apparatus for selecting a beam in consideration of interference.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DETAILED DESCRIPTION OF THE INVENTION

### Technical Problem

Various embodiments of the disclosure may provide a beam selection apparatus and method in a wireless communication system.

Various embodiments of the disclosure may provide a method and apparatus for selecting an optimal beam in consideration interference from various beams in a wireless communication system.

### Technical Solution

According to various embodiments of the disclosure, a method performed by a base station in a wireless communication system may include an operation of transmitting, to a user equipment (UE), a first signal including information related to received-power, receiving, from the UE, a second signal including information on received-power of the UE, transmitting, to a network entity, the information on received-power, and receiving, from the network entity, a received-power matrix.

In addition, the received-power matrix may include at least one of a transmission index, a transmission beam index, and a reception index or reception beam index, the first signal may include a synchronization signal block (SSB), and the second signal may include a channel state information (CSI) report.

In addition, the method may further include an operation of identifying, based on the received received-power matrix, interference to the UE.

The method may further include an operation of determining a candidate beam set by selecting a predetermined number of beams from among available transmission beams, identifying, based on the received received-power matrix, a number of UEs satisfying a quality of service (QoS), for each beam of the candidate beam set, in case that a corresponding beam is used, and determining, as a final beam, a beam that has a largest number of UEs satisfying the QoS from among the candidate beam set.

In addition, the operation of determining the candidate beam set may comprise an operation of selecting a predetermined number of beams in order of a highest signal to interference plus noise ratio (SINR).

According to various embodiments of the disclosure, a method performed by a network entity in a wireless communication system may include, receiving, from a base station, information on received-power of at least one user equipment (UE), updating a received-power matrix based on the information on the received-power, and transmitting, to the base station, the updated received-power matrix.

According to various embodiments of the disclosure, a method performed by a user equipment (UE) in a wireless communication system may include, receiving, from a base station, a first signal including information related to received-power, identifying, based on the first signal, information on received-power of the UE, and transmitting, to the base station, a second signal including the information on the received-power of the UE.

In addition, the first signal may include a synchronization signal block (SSB), and the information associated with the received-power of the UE may include at least one of a transmission index, a transmission beam index, and received-power of a reference signal.

In addition, the second signal may include a channel state information (CSI) report.

According to various embodiments of the disclosure, a base station in a wireless communication system may include a transceiver and at least one processor, and the at least one processor may be configured to transmit, to a user equipment (UE), a first signal including information on received-power, to receive, from the UE, a second signal including information on received-power of the UE, to transmit, to a network entity, the information associated with the received-power, and to receive a received-power matrix from the network entity.

According to various embodiments of the disclosure, a network entity in a wireless communication system may include a transceiver and at least one processor, and the at least one processor may be configured to receive, from a base station, information on received-power at least one UE, to update a received-power matrix based on the information on received-power, and to transmit, to the base station, the updated received-power matrix.

### Advantageous Effects

According to various embodiments of the disclosure, beam selection in consideration of various types of interference is facilitated in a wireless communication system.

According to various embodiments, beam selection in consideration of interference from a user equipment (UE) in a wireless communication system allows effective communication.

According to various embodiments of the disclosure, an optimal method for satisfying QoS of UEs in a wireless communication system may be considered.

Advantageous effects obtainable from various embodiments of the disclosure may not be limited to the above-mentioned effects, and other effects which are not mentioned may be clearly understood from the following descriptions by those skilled in the art to which the disclosure pertains.

### BRIEF DESCRIPTION OF DRAWINGS

The above and other aspects, features, and advantages will be more apparent from the following description of embodiments of the disclosure with reference to the accompanying drawings.

FIG. 1 is a diagram illustrating beams associated with communication and interference between a base station and a user equipment (UE) in a communication system;

FIG. 2A is a diagram illustrating a relationship between a base station and a core network according to an embodiment of the disclosure. FIG. 2B is a diagram illustrating a structure of a network according to various embodiments of the disclosure;

FIG. 3 is a diagram illustrating an operation of performing communication in a network according to an embodiment of the disclosure;

FIG. 4 is a diagram illustrating a received-power matrix according to an embodiment of the disclosure;

FIG. 5 is a diagram illustrating a method of performing communication by utilizing a received-power matrix according to an embodiment of the disclosure;

FIG. 6 is a diagram illustrating a structure of a base station according to embodiments of the disclosure;

FIG. 7 is a diagram illustrating a structure of a UE according to embodiments of the disclosure;

FIG. 8 is a diagram illustrating a structure of a network entity according to embodiments of the disclosure; and

FIG. 9 is a diagram schematically illustrating another example of the internal structure of a UE in a wireless communication system according to various embodiments of the disclosure.

### MODE FOR CARRYING OUT THE INVENTION

Hereinafter, embodiments of the disclosure will be described with reference to the accompanying drawings.

In describing the embodiments, descriptions related to technical contents well-known in the relevant art and not associated directly with the disclosure will be omitted.

Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. Throughout the specification, the same or like reference signs indicate the same or like elements.

The advantages and features of the disclosure and ways to achieve them will be apparent by making reference to embodiments as described below in detail in conjunction with the accompanying drawings.

However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the term “unit” refers to a software element or a hardware element, such as a field programmable gate array (FPGA) or an application specific integrated circuit (ASIC), and the “unit” may perform certain functions. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card.

In the following description, some of terms and names defined in the 3rd generation partnership project (3GPP) standards (standards for 5G, NR, LTE, or similar systems) may be used for the convenience of description. Use of these terms is not intended to limit the disclosure by the terms and names, and the disclosure may be applied in the same way to systems that conform other standards, and may be changed into other forms without departing from the technical idea of the disclosure.

Furthermore, as used in the disclosure, the expression “greater than” or “less than” is used to determine whether a specific condition is satisfied or fulfilled, but this is intended only to illustrate an example and does not exclude “greater than or equal to” or “equal to or less than”. A condition indicated by the expression “greater than or equal to” may be replaced with a condition indicated by “greater than”, a condition indicated by the expression “equal to or less than” may be replaced with a condition indicated by “less than”, and a condition indicated by “greater than and equal to or less than” may be replaced with a condition indicated by “greater than and less than”.

In the following, a terminal will be described in various embodiments of the disclosure, but the terminal may also be called an electronic device, a mobile station, a mobile equipment (ME), a user equipment (UE), a user terminal (UT), a subscriber station (SS), a wireless device, a handheld device, or an access terminal (AT). Alternatively, in various embodiments of the disclosure, the terminal may be a device having a communication function, such as a mobile phone, a personal digital assistant (PDA), a smartphone, a wireless modem, or a notebook.

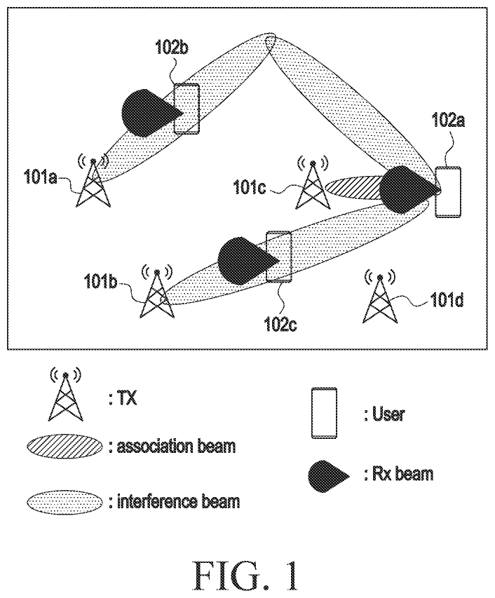

FIG. 1 is a diagram illustrating beams associated with communication and interference between a base station and a user equipment (UE) in a communication system.

Referring to FIG. 1, interference may occur due to communication among base stations 101a, 101b, 101c, and 101d and UEs, and among UEs 102a, 102b, and 102c, in a superhigh frequency (mmWave) band. The UE 1 102a may receive a beam for communication from the base station 3 101c. However, a beam acting as interference may be received in the communication between the UE 1 102a and the base station 3 101c. For example, interference may occur when a signal generated in the communication between the base station 2 101b and the UE 3 102c is directly received by the UE 1 102a, and interference may occur when a signal generated in the communication between the base station 1 101a and the UE 2 102b is received by the UE 1 102a via reflection. That is, direct interference may occur in the case of a line of sight (Los), and interference via reflection may occur in the case of a non-line of sight (NLoS).

In a superhigh frequency (mmWave) band, such interference acts as a disruption to achievement of a predetermined level of QoS at a UE, and thus a method of applying beam selection in consideration of interference may be considered in order to obtain an increased QoS.

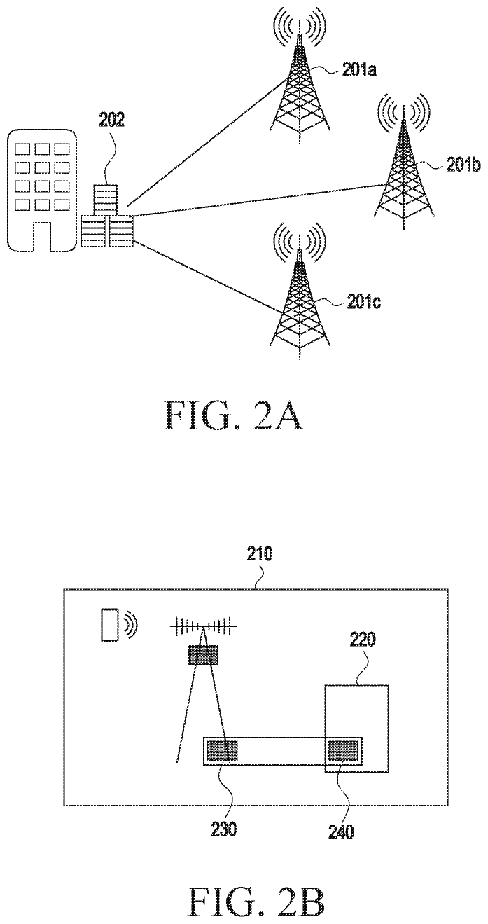

FIG. 2A is a diagram illustrating a relationship between a base station and a core network according to an embodiment of the disclosure. FIG. 2B is a diagram illustrating a structure of a network according to various embodiments of the disclosure.

Referring to FIG. 2A, the illustrated structure of a next generation base station may be expressed as a cloud-RAN (C-RAN) or centralized-RAN (C-RAN), and may be configured in an advanced form of a distributed base station system. The C-RAN may enable signal transmission using a superhigh frequency (mmWave) band and may have a large-scale centralized base station deployment. In the C-RAN, a baseband unit (BBU) may be moved to the center of a cell site. In the C-RAN, each base station 201a, 201b, and 201c may be connected to a baseband unit (BBU) pool 202 located in the center, and may be controlled. In the case of the C-RAN, a centralized unit (CU) may easily collect information related to each decentralized unit (DU), and manage resources.

Referring to FIG. 2B, a network structure including a C-RAN according to various embodiments of the disclosure may be identified. A network may include an RAN 210 expressed as an antenna and a server farm 220 included in a core network. The RAN 210 may include a radio unit (RU) and a DU 230, and the server farm 220 may include a CU 240. Here, the DU 230 and the CU 240 may include different layers from each other. For example, the DU 230 and the CU 240 may include a packet data convergence protocol (PDCP) layer, a radio resource control (RRC) layer, a radio link control (RLC) layer, a medium access control (MAC) layer, a physical layer (PHY), and a radio frequency (RF) layer.

According to various embodiments, the layers may be distributed to the RU and DU 230 included in the RAN 210 and to the CU 240 of the server farm 220. According to an embodiment, an RLC layer, a MAC layer, a PHY layer, and an RF layer may be included in the RU and DU, and a PDCP layer and an RRC layer may be distributed to the CU. According to another embodiment, a PHY layer and an RF layer may be included in the RU and the DU, and an RLC layer, a MAC layer, a PDCP layer, and an RRC layer may be distributed to the CU. According to another embodiment, part of a PHY layer and an RF layer may be included in the RU and DU, and an RLC layer, a MAC layer, a PDCP layer, an RRC layer, and part of the PHY layer may be distributed to the CU. According to another embodiment, an RF layer may be included in the RU and DU, and an RLC layer, a MAC layer, a PHY layer, a PDCP layer, and an RRC layer may be distributed to the CU.

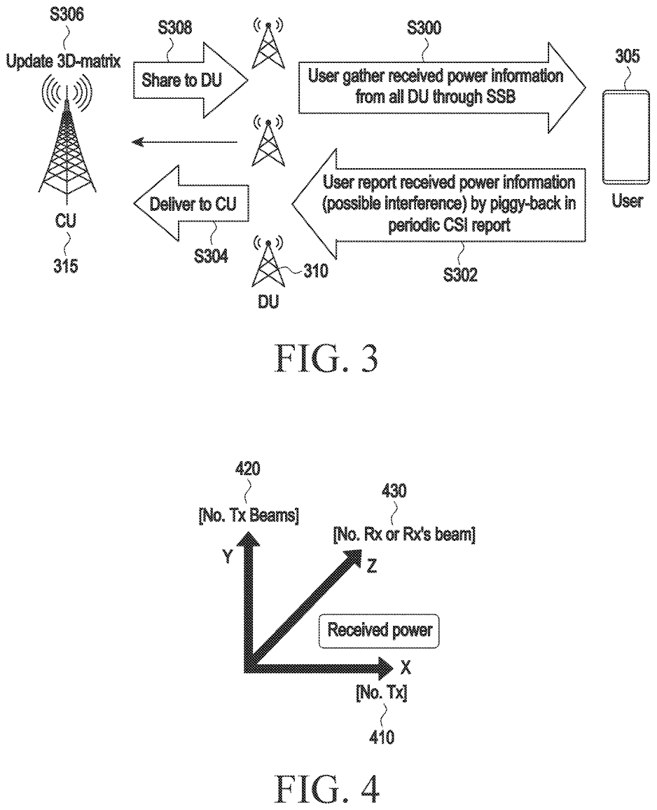

FIG. 3 is a diagram illustrating an operation of performing communication in a network according to an embodiment of the disclosure.

Referring to FIG. 3, a user equipment (UE) 305 may obtain received-power information from each of at least one base station (or DU) 310 including a DU in operation S300. According to an embodiment, the at least one base station 310 may transmit a signal including each synchronization signal block (SSB) to the UE 305, and the UE 305 may obtain, based on the SSB, received-power information associated with each of the at least one base station. For example, the UE 350 may obtain, from the SSB, at least one of a transmission number (Tx number), a beam number, and received power information from reference signal in association with the corresponding base station. For example, a transmission number may be an ID or index of a base station. A beam number may be an index of a beam, and received power information from reference signal may be information associated with a received-power strength measured using an RS (e.g., a DMRS for a PBCH) based on the SSB.

According to an embodiment, 20 ms, 40 ms, 80 ms, or 160 ms may be configured as an interval for the SSB (SSB interval). In addition, 1 ms, 2 ms, 2.5 ms, or 5 ms may be configured as a duration for the SSB (SSB duration).

The UE 305 may report, based on the obtained information, information related to received-power to the at least one base station 310 in operation S302. The UE 305 may transmit, to the base station 310 that the UE 305 communicates with, power information (or information associated with an interference probability) in a channel state information (CSI) (periodic or aperiodic) report via piggyback.

According to an embodiment, the CSI report from the UE to the base station may be performed by using a physical uplink shared channel (PUSCH). Both a periodic report and an aperiodic report may be used for a CSI report. When periodic report is used, an interval may be configured to 5 ms, 10 ms, 20 ms, 40 ms, or 80 ms. The period may be changed based on a change of a channel condition.

The at least one base station 310 may receive the power information (or information associated with an interference probability) received from the UE 305, and may transmit the same to the core network including a CU (or the CU itself) 315 in operation S304. The power information may be used for generating or updating a received-power matrix (or C-RAN received power 3D-matrix).

The core network (or CU) 315 may receive the power information from the at least one base station 310, and may generate or update the received-power matrix (or C-RAN received power 3D-matrix) based on the received power information in operation S306.

According to an embodiment, an interval for updating the received-power matrix may be configured to a least common multiple of the interval of the SSB and the interval of the CSI. Here, the SSB duration may be included in the SSB interval. The size of the generated received-power matrix may be configured to a product of a transmission number (or transmission index), a transmission beam number (or transmission beam index), a reception number (or reception index), a reception beam number (or reception beam index), and transmission power. For example, the size of the generated received-power matrix may be 15 to 20 bits. The size of each reception report related to transmission may be configured to a product of a transmission number (or transmission index), a transmission beam number (or transmission beam index), a reception beam number (or reception beam index), and transmission power. For example, the size of generated each reception report may be 12 to 15 bits. Information having a size of approximately 12 to 20 bits may be a size sufficient for the CU to control.

The core network 315 may transfer the generated or updated received-power matrix to the at least one base station 310 in operation S308. Based on the received updated received-power matrix, the at least one base station 310 may estimate a probability of interference. In addition, it may communicate with the UE 305 by selecting a beam based on the estimated interference.

According to an embodiment, the UE may receive at least one SSB from each of the at least one DU (or base station), may obtain received-power related information (Tx number, beam number, received power information) based on each SSB (each DU's SSB), and may transmit, to the DU, the obtained received-power related information via a CSI report. The DU may transfer the received information to the CU. Based on the received power related information, the CU may generate a received-power 3D matrix and transfer the same to each DU, and each DU may update the received-power 3D matrix and apply the same to the communication with the UE.

FIG. 4 is a diagram illustrating a received-power matrix according to an embodiment of the disclosure. The received-power matrix may indicate an interference recognition probability in a C-RAN.

Referring to FIG. 4, according to an embodiment, a received-power matrix (or C-RAN received power 3D-matrix) may include three elements. The received-power matrix may include a transmission number (Tx number) 410, a TX beam number 420, a reception number (Rx number) 430, or an RX beam number. For example, x-axis may be configured to represent a Tx number, y-axis may be configured to represent a Tx beam number, and z-axis may be configured to represent an RX number or RX beam number, and the axes are not limited thereto but may be configured variously. The size of the received-power matrix may be configured to a product of a Tx number (or transmission index), a Tx beam number (or transmission beam index), an RX number (or reception index), an RX beam number (or reception beam index), and transmission power. The values of the axes may represent a received-power value (or interference probability).

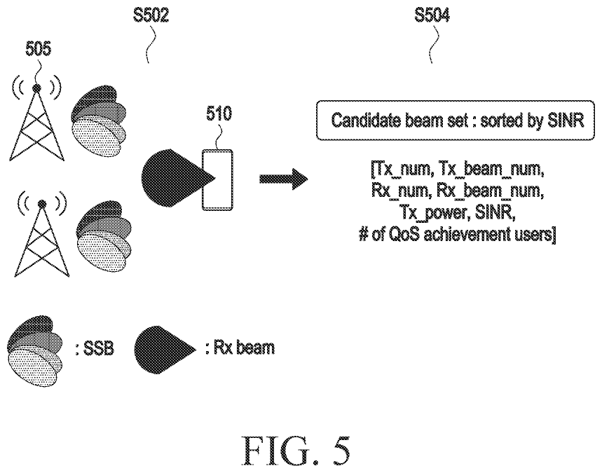

FIG. 5 is a diagram illustrating a method of performing communication by utilizing a received-power matrix according to an embodiment of the disclosure.

A base station of FIG. 5 may be the same as the base station described with reference to FIGS. 1 to 4. In addition, the base station of FIG. 5 may identify a received-power matrix generated or updated in FIGS. 1 to 4 described above.

Referring to FIG. 5, a base station 505 may configure a candidate beam set including at least one beam for communicating with at least one UE 510. The base station 505 may measure a signal to interference-plus-noise ratio (SINR) of each beam in order to determine the candidate beam set including at least one beam, and configure k beams, wherein k is an arbitrary number, in order of the highest SINR from among all available transmission beams in operation S502. The arbitrary number k may be determined by an operator in advance or by a user in advance.

When the candidate beam set including at least one beam is determined, the base station 505 may select a final beam to perform communication with the at least one UE 510 from the candidate beam set. The base station 505 may select a final beam so that a maximum number of UEs satisfy the QoS of communication in operation S504. The base station 505 may recognize probable interference by using the received-power matrix received from a CU as described with reference to FIGS. 1 to 4. The base station 505 may recognize interference by using the received-power matrix, and may determine whether the QoS of a UE (user) is satisfied. When the total sum of the number of UEs (users) satisfying QoS is the same, the base station 505 may select a beam having a higher SINR.

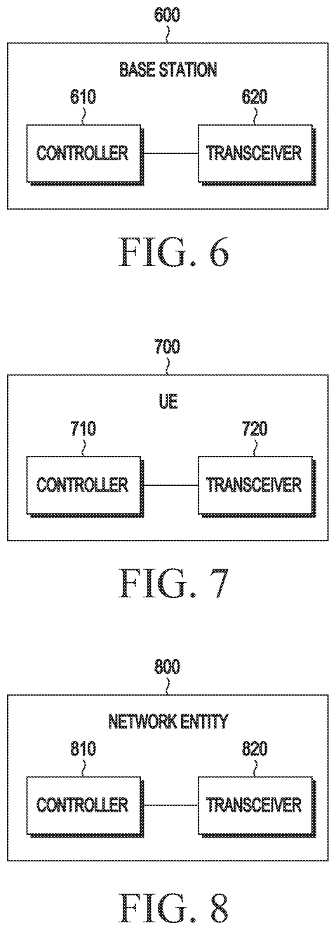

FIG. 6 is a diagram illustrating a structure of a base station according to embodiments of the disclosure The base station of FIG. 6 may be a base station including a DU. As illustrated in FIG. 6, a base station (BS) of the disclosure may include at least one controller (processor) 610 and a transceiver 620 including a receiver and a transmitter. The BS may include memory (not illustrated). The transceiver 620 and the memory may be connected to the at least one controller 610 and may operate under the control of the at least one controller 610.

The at least one controller 610 may control a series of processes so that the operation of the BS described with reference to FIGS. 1 to 5 is performed. The transceiver 620 may perform signal transmission or reception with a UE 700 and another network entity 800. The signal may include a control message, data information, or the like.

FIG. 7 is a diagram illustrating a structure of a user equipment (UE) according to embodiments of the disclosure. As illustrated in FIG. 7, a UE of the disclosure may include at least one controller (processor) 710 and a transceiver 720 including a receiver and a transmitter. The UE may include memory (not illustrated). The transceiver 720 and the memory may be connected to the at least one controller 710 and may operate under the control of the at least one controller 710.

The at least one controller 710 may control a series of processes so that the operation of the UE described with reference to FIGS. 1 to 5 is performed. The transceiver 720 may perform signal transmission or reception with the BS 600 and the network entity 800. The signal may include control information, data, or the like.

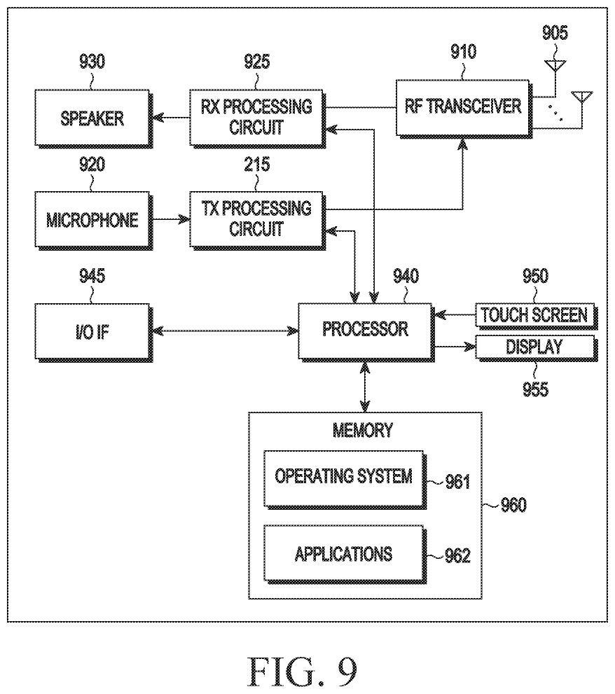

FIG. 8 is a diagram illustrating a structure of a network entity according to embodiments of the disclosure. The network entity of FIG. 8 may be a device including a CU of the disclosure. As illustrated in FIG. 8, a core network entity of the disclosure may include at least one controller (or processor) 810 and a transceiver 820 including a receiver and a transmitter. The core network entity may include memory (not illustrated). The transceiver 820 and the memory may be connected to the at least one controller 810 and may operate under the control of the at least one controller 810.

The at least one controller 810 may control a series of processes so that the operation of the network entity described in the embodiments of FIGS. 1 to 5 is performed. The transceiver 820 may perform signal transmission or reception with the BS 600 and the UE 700. The signal may include control information, data, or the like.

FIG. 9 is a diagram schematically illustrating another example of the internal structure of a user equipment (UE) in a wireless communication system according to various embodiments of the disclosure.

The embodiment of the UE illustrated in FIG. 9 is merely an example, and thus FIG. 9 does not limit the scope of the disclosure to a predetermined embodiment of a UE.

As illustrated in FIG. 9, the UE may include an antenna 905, a radio frequency (RF) transceiver 910, a TX processing circuit 915, a microphone 920, and a receive (RX) processing circuit 925. The UE may include a speaker 930, a processor (controller) 940, an input/output (I/O) interface (IF) 945, a touch screen 950, a display 955, and memory 960. The memory 960 may include an operating system (OS) 961 and one or more applications 962.

The RF transceiver 910 may receive, from the antenna 905, an RF signal transmitted and input by a BS of a network. The RF transceiver 910 may down-convert the input RF signal so as to generate an intermediate frequency (IF) or a baseband signal. The IF or baseband signal may be transmitted to the RX processing circuit 925, and the RX processing circuit 925 may perform filtering, decoding, and/or digitalization on the baseband or IF signal so as to generate a processed baseband signal. The RX processing circuit 925 may transmit the processed baseband signal to the speaker 930 (for sound data) or to the processor 940 (for web browsing data) in order to perform additional processing.

The TX processing circuit 915 may receive analog or digital sound data from the microphone 920, or may receive another output baseband data (e.g., web data, e-mail, or interactive video game data) from the processor 940. The TX processing circuit 915 may encode, multiplex, and/or digitalize the output baseband data so as to generate a processed baseband or IF signal. The RF transceiver 910 may receive the processed baseband or IF signal output from the TX processing circuit 915, and may up-convert the baseband or IF signal into an RF signal to be transmitted via the antenna 905.

The processor 940 may include one or more processors or other processing devices, and may implement the OS 961 stored in the memory 960 in order to control the overall operation of the UE. For example, the processor 940 may control reception of downlink channel signals and transmission of uplink channel signals via the RF transceiver 910, the RX processing circuit 925, and the TX processing circuit 915 according to the well-known principals. In some embodiments, the processor 940 may include at least one microprocessor or microcontroller.

According to various embodiments of the disclosure, the processor 940 may control the overall operation related to network access and session management of a UE. That is, the processor 940 may control the overall operation associated with network access and session management as described with reference to FIGS. 1 to 8.

The processor 940 may move data to the memory 960 or from the memory 960 when requested by a process being implemented. In some embodiments, based on the OS program 961 or in response to signals received from base stations or operators, the processor 940 may be configured to implement the applications 962. In addition, the processor 940 may be connected to the I/O interface 945, and the I/O interface 945 may provide, to the UE, a capability of connecting to other devices such as laptop computers and handheld computers. The I/O interface 945 may be a communication path between these accessories and the processor 940.

The processor 940 may also be connected to the touch screen 950 and the display unit 955. An operator of the UE may input data to the UE by using the touch screen 950. The display 955 may be a liquid crystal display, a light emitting diode display, or other displays capable of rendering text and/or at least limited graphics from web sites or the like.

The memory 960 may be connected to the processor 940. A part of the memory 960 may include a random access memory (RAM), and the remaining part of the memory 960 may include flash memory or other read-only memory (ROM).

Although FIG. 9 illustrates an example of a UE, various modifications of the example of FIG. 9 may be made. For example, various components of FIG. 9 may be combined, may be further divided, or may be omitted, or other components may be added in response to a particular need. In addition, as a special example, the processor 940 may be divided into multiple processors, such as one or more central processing units (CPUs) and one or more graphics processing units (GPUs). In addition, although the UE is configured as a mobile phone or a smartphone in FIG. 9, the UE may be configured to operate as different types of mobile or stationary devices.

In the drawings in which methods of the disclosure are described, the order of the description does not always correspond to the order in which steps are performed, and the order relationship between the steps may be changed or the steps may be performed in parallel.

Alternatively, in the drawings in which methods of the disclosure are described, some elements may be omitted and only some elements may be included therein without departing from the essential spirit and scope of the disclosure.

Although exemplary embodiments of the disclosure have been described and shown in the specification and the drawings by using particular terms, they have been used in a general sense merely to easily explain the technical contents of the disclosure and help understanding of the disclosure, and are not intended to limit the scope of the disclosure. It will be apparent to those skilled in the art that, in addition to the embodiments set forth herein, other variants based on the technical idea of the disclosure may be implemented.

That is, although specific embodiments have been described in the detailed description of the disclosure, it will be apparent that various modifications and changes are possible without departing from the scope of the disclosure, and the scope of the disclosure should not be limited to the described embodiments, but should be defined by the appended claims and equivalents thereof.

1-15. (canceled)

16. A method performed by a base station in a wireless communication system, the method comprising:
transmitting, to a user equipment (UE), a first signal including information related to received-power;
receiving, from the UE, a second signal including information on received-power of the UE;
transmitting, to a network entity, the information on received-power; and
receiving, from the network entity, a received-power matrix.

17. The method of claim 16, wherein the received-power matrix includes at least one of a transmission index, a transmission beam index, and a reception index or reception beam index.

18. The method of claim 16, further comprising:
identifying, based on the received-power matrix, interference to the UE.

19. The method of claim 18, further comprising:
determining a candidate beam set by selecting a predetermined number of beams from among available transmission beams;
identifying, based on the received-power matrix, a number of UEs satisfying a quality of service (QoS) for each beam of the candidate beam set in case that a corresponding beam is used; and
determining, as a final beam, a beam which has a largest number of UEs satisfying the QoS from among the candidate beam set.

20. The method of claim 19, wherein the determining of the candidate beam set comprises selecting a predetermined number of beams in order of a highest signal to interference plus noise ratio (SINR).

21. The method of claim 16, wherein the first signal includes a synchronization signal block (SSB).

22. The method of claim 16, wherein the second signal includes a channel state information (CSI) report.

23. The method of claim 16, wherein the received-power matrix is updated by the network entity based on the information on received-power.

24. A method performed by a user equipment (UE) in a wireless communication system, the method comprising:
receiving, from a base station, a first signal including information related to received-power;
identifying, based on the first signal, information on received-power of the UE; and
transmitting, to the base station, a second signal including the information on received-power of the UE.

25. The method of claim 24,
wherein the first signal includes a synchronization signal block (SSB), and
wherein the information on received-power of the UE includes at least one of a transmission index, a transmission beam index, and received-power of a reference signal.

26. The method of claim 24, wherein the second signal includes a channel state information (CSI) report.

27. A base station in a wireless communication system, the base station comprising:
a transceiver; and
at least one processor,
wherein the at least one processor is configured to:
transmit, to a user equipment (UE), a first signal including information related to received-power,
receive, from the UE, a second signal including information on received-power of the UE,
transmit, to a network entity, the information on received-power, and
receive, from the network entity, a received-power matrix.

28. The base station of claim 27, wherein the received-power matrix includes at least one of a transmission index, a transmission beam index, and a reception index or reception beam index.

29. The base station of claim 27, wherein the first signal includes a synchronization signal block (SSB).

30. The base station of claim 27, wherein the second signal includes a channel state information (CSI) report.

31. The base station of claim 27, wherein the at least one processor is further configured to:
identify, based on the received-power matrix, interference to the UE.

32. The base station of claim 31, wherein the at least one processor is further configured to:
determine a candidate beam set by selecting a predetermined number of beams from among available transmission beams,
identify, based on the received-power matrix, a number of UEs satisfying a quality of service (QoS) for each beam of the candidate beam set in case that a corresponding beam is used, and
determine, as a final beam, a beam which has a largest number of UEs satisfying the QoS from among the candidate beam set.

33. A user equipment (UE) in a wireless communication system, the UE comprising:
a transceiver; and
at least one processor,
wherein the at least one processor is configured to:
receive, from a base station, a first signal including information related to received-power,
identify, based on the first signal, information on received-power of the UE, and
transmit, to the base station, a second signal including the information on received-power of the UE.

34. The UE of claim 33,
wherein the first signal includes a synchronization signal block (SSB), and
wherein the information on received-power of the UE includes at least one of a transmission index, a transmission beam index, and received-power of a reference signal.

35. The UE of claim 34, wherein the second signal includes a channel state information (CSI) report.
